(19) United States
(12) Patent Application Publication
(10) Pub. No.: US 2023/0005262 A1
(43) Pub. Date: Jan. 5, 2023

(54) SYSTEM AND METHOD FOR DYNAMIC SYNCHRONIZATION BETWEEN REAL AND VIRTUAL ENVIRONMENTS

(71) Applicant: Alon MELCHNER, Rosh Haayin (IL)

(72) Inventor: Alon MELCHNER, Rosh Haayin (IL)

(21) Appl. No.: 17/779,435

(22) PCT Filed: Nov. 25, 2020
(86) PCT No.: PCT/IL2020/051210

§ 371 Date: May 24, 2022

Related U.S. Application Data
(60) Provisional application No. 62/939,737, filed on Nov. 25, 2019.

(51) Int. Cl. G06V 20/20; A63F 13/28; G06F 3/01; G06T 19/00

(52) U.S. Cl. CPC G06V 20/20; A63F 13/28; G06F 3/011; G06T 19/006

(57) ABSTRACT

The invention relates to a mixed reality system for dynamic synchronization between real and virtual environments, allowing a virtual stimulus superimposed on or near a real object in a real world location to create a physical reaction in the real world, as if the virtual stimulus were real. The system comprises reactive piece(s) and a mechanism for tracking the reactive piece(s), a stimulizing mechanism for translating user motions into virtual stimuli, and a virtuality-reality synchronizer to compute appropriate reaction parameters of reactive piece(s) to a virtual stimulus, as if the stimulus were really applied to the physical piece. Each reactive piece has a reaction mechanism, e.g. a moving or vibrating component, actuated by a signal comprising the reaction parameters. When the reaction mechanism is actuated it can, for example, destabilize the object in a predetermined manner. Destabilization can be varied to reflect the power or effectiveness of the virtual stimulus.

### FIELD OF THE INVENTION

The invention is in the field of mixed reality, and in particular relates to a system for synchronizing physical and simulated realities and enabling physical objects to react to virtual visual stimuli.

### BACKGROUND TO THE INVENTION

Augmented reality games are layers of virtual worlds that are superimposed on the real environment, sometimes acting as layers to real environment objects such as toys, engineering devices, furniture, etc.

Mixed reality (MR) is the merging of real and virtual worlds to produce new environments and visualizations, where physical and digital objects co-exist and interact in real time. Mixed reality does not exclusively take place in either the physical or virtual world, but is a hybrid of reality and virtual reality, encompassing a spectrum of real and virtual elements.

For example, different applications have been created with Lego® blocks that enable virtual layers to be connected or follow the physical toys or pieces, these layers appear “floating” near the physical pieces, without affecting them.

Among existing games in the virtuality-reality spectrum, an augmented reality (AR) game, SpecTrek, projects ghosts at various locations on a Google map in either a predetermined search radius or a user-defined search radius. To play, the user must walk to ghosts within their range. The user can scan and find out what kind of ghost is nearby as well as how far the ghost is from their current position. If the user is unable to reach a ghost, a horn may be blown which makes all nearby ghosts flee and possibly stop within reach of another accessible location. The user catches ghosts by scanning the ghosts with their cameras.

### SUMMARY

The present invention relates to a mixed reality system for dynamic synchronization between real and virtual environments, allowing a virtual stimulus superimposed on or near a real object in a real world location to create a physical reaction in the real world, as if the virtual stimulus were real. The system comprises reactive piece(s) and a mechanism for tracking the reactive piece(s), a stimulizing mechanism for translating user motions into virtual stimuli, and a virtuality-reality synchronizer to compute appropriate reaction parameters of reactive piece(s) to a virtual stimulus, as if the stimulus were really applied to the physical piece. Each reactive piece has a reaction mechanism, for example a moving or vibrating component, which may be actuated by a signal comprising the reaction parameters. When the reaction mechanism is actuated it can, for example, destabilize the object in a predetermined manner. The destabilization can be varied in a manner to reflect the power or effectiveness of the virtual stimulus.

### BRIEF DESCRIPTION OF THE DRAWINGS

FIG. 1 shows an MR gaming system, according to some embodiments of the invention.

FIG. 2 shows a reaction mechanism of reactive pieces in an MR gaming system, according to some embodiments of the invention.

### DETAILED DESCRIPTION

“Virtual physics,” as used in this disclosure, refers to the computer simulation of interactions and/or reactions of virtual objects.

“Virtuality-to-reality synchronization” refers to the computational modeling of virtual stimuli and reactions of physical objects to the virtual stimuli, and how to implement the reactions in reaction mechanisms integrated into the physical objects.

“Reality-to-virtuality synchronization” refers to updating the computational model to account for the physical stimulus.

“Prompt” refers to action(s) by a user that cause(s), in whole or in part, a system of the invention to initiate a virtual stimulus and implement one or more particular physical reactions of one or more physical objects to the virtual stimulus as if it were real.

The present disclosure relates to a mixed reality gaming system. It is appreciated that the principles disclosed herein can be applied to other mixed reality applications, including education, training, physical therapy, occupational therapy, remote surgery, industrial use, theme parks, smart cities, advertisements and interactive shopping, among others.

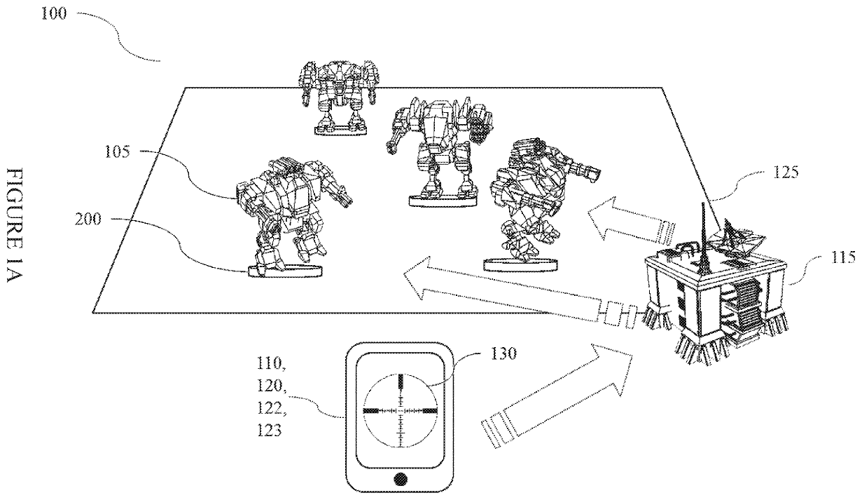

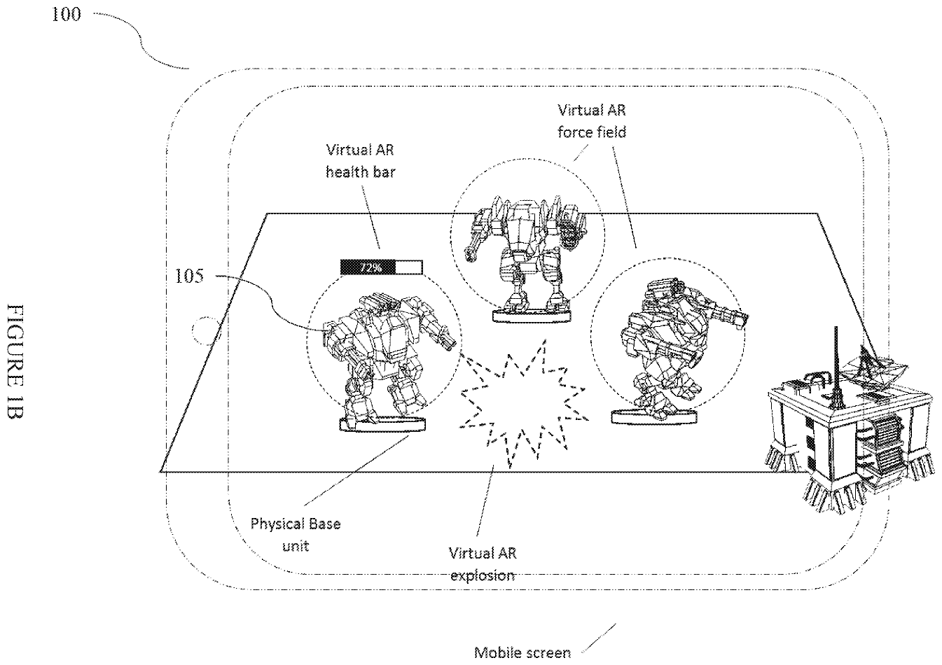

Reference is now made to FIG. 1, showing a mixed reality gaming system, according to some embodiments of the invention.

Mixed reality gaming system 100 comprises reactive pieces 105, each with a reaction mechanism configured to cause a physical reaction of the reactive piece 105. The physical reaction can be toppling or tilting of reactive piece 105, as further described herein. The reaction mechanism may be part of a base 200, further described herein, of reactive piece 105. Reactive pieces 105 may be stationary or may be moving on a real operative surface 125.

Mixed reality gaming system 100 further comprises a tracking mechanism 110 that tracks physical parameters of reactive pieces 105. Such physical parameters may describe a physical position, a physical orientation, identifying features, and/or physical motion of reactive pieces 105 on operative surface 125. Detection mechanism 110 can be a part of a user device (with a specialized application installed), as shown. Alternatively, or additionally, detection mechanism can be an external apparatus. Tracking mechanism 110 may store fixed initial positions of reactive pieces, such as reactive bowling pins in an MR bowling game, further described herein.

Tracking mechanism 110 can comprise a camera and processor of a user device, as shown, equipped with a specialized application. A user scans the camera through the reactive pieces 105. Alternatively, tracking mechanism 110 with similar functionality can be embedded in MR smart glasses. The scan can acquire images of QR codes on the pieces 105 or images of the pieces 105 themselves. The processor employs a computer vision algorithm to associates the images with identifiers of the pieces 105; the processor may implement the association in cooperation a pieces control unit 115, further described herein. The processor then computes their position; for example, using a computer vision methodology such as AR and/or SLAM technology.

Tracking mechanism 110 may, alternatively or in addition, comprise a wireless triangulation system.

Tracking mechanism 110 may, alternatively or in addition, comprise one or more touch-sensitive surfaces (e.g., mats) disposed on the operative surface 125. Locations of the pieces 105 can be determined by where the touch-sensitive surface is depressed. Additionally, each reactive pieces 105 can have a unique footprint, each footprint shape associated a unique identifier of the piece 105. If the pieces are moving, the touch-sensitive surface(s) continue to track locations of the reactive pieces 105.

System 100 further comprises a stimulizing mechanism 120, in communicative connection with tracking mechanism 110 and/or reactive pieces 105. Stimulizing mechanism 120 detects one or more motions of one or more users. For example, the user motion detected by stimulizing mechanism 120 can be the pulling a trigger while aiming tracking mechanism 110 at one of reactive pieces 105. Stimulizing mechanism 120 then computes parameters of one or more virtual stimuli of one or more reactive pieces 105, caused by the user motion(s). For example, stimulizing mechanism 120 may compute visual and/or acoustic virtual stimuli of a gun triggered by the user, in the aiming direction of tracking mechanism 110, such as direction, velocity, power, virtual bullet location on a reactive target 105 etc. of the virtual gunshot.

In some embodiments, stimulizing mechanism 120 detects limbs of a user; for example, throwing motions of the arms or kicking motions of the legs, captured by a video camera, for example. Stimulizing mechanism 120 may then implement a computer-vision algorithm to compute stimulus parameters as a function of the user motions, such as an initial velocity and direction of a virtual ball or dart, for example.

Stimulizing mechanism 120 can comprise a user motion detector and a processor of a user device, as shown, equipped with a specialized application. The user motion detector could be a gyro, a compass, a tilt-sensor, a camera, or any combination thereof. Alternatively, stimulizing mechanism 120 with similar functionality can comprise MR smart glasses and an MR gun, for example.

System 100 further comprises a mixed-reality output mechanism 122. MR output mechanism 122 receives the virtual stimulus parameters and conveys to the user a superposition of the virtual stimulus over a reactive piece 105. The MR output mechanism 122 may, for example, display the visual effects of a gunshot over an image of reactive piece 105. MR output mechanism may comprise an output screen of a user device, or smart glasses. MR output mechanism may comprise a speaker (e.g., of the user device), for example blaring the sound of the virtual gunfire.

FIG. 1B shows some of the effects that may appear in MR output mechanism 122, such as a virtual explosion 130, a virtual AR force field 135, and a virtual AR health bar 140 (showing the “health” of a reactive piece 105 during a “battle”). In some embodiments, MR output mechanism 122 may be further equipped to give a reaction to the user, such as a recoil “kick.”

System 100 further comprises a virtuality-reality (V-R) synchronizer 123. V-R synchronizer 123 comprises a processor that receives the virtual stimulus parameters and computes physical reaction parameters of a physical reactive piece 105 to the virtual stimulus, as if the virtual stimulus takes place in the real physical world. The reaction parameters are computed according to how the virtually stimulated reactive piece 105 should react to the stimulus. V-R synchronizer 123 then sends the reaction parameters to the reaction mechanism of the virtually stimulated reactive piece 105. The reaction mechanism implements the reaction parameters. The reaction can be for the virtually shot reactive piece to fall, to kneel (e.g., if a virtual shot missed), to run, and the like. Upon effecting the reaction, V-R synchronizer 123 may re-formulate a model of the MR environment, based on the new reality in the physical world, and use the re-formulated model in future computation of reaction parameters.

In some embodiments, system 100 further comprises a pieces control unit (PCU) 115, in communicative connection with a user device—comprising tracking mechanism 110, stimulizing mechanism 120, and MR output mechanism—and reactive pieces 105. PCU 115 implements functions of virtual-reality synchronizer 123 (in whole or in part), thereby alleviating the user device of computational effort required to compute physical reaction parameters from virtual stimulus parameters. PCU 115 may also track the statuses (e.g., AR health) of reactive pieces 105, and report these to one or more user devices, so that in a multi-user embodiment of system 100, all user devices can be updated of the piece statuses.

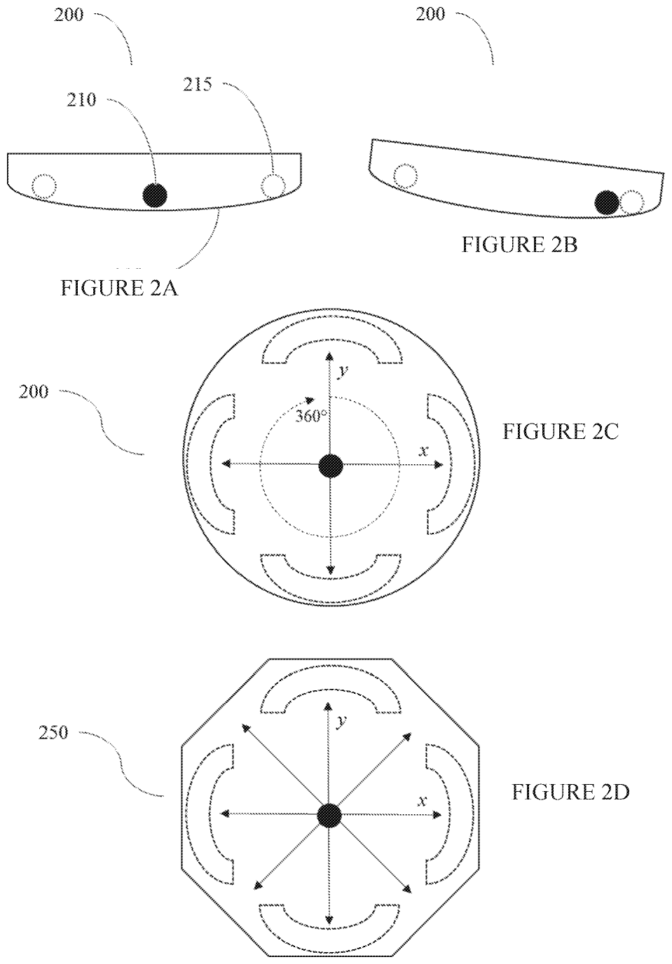

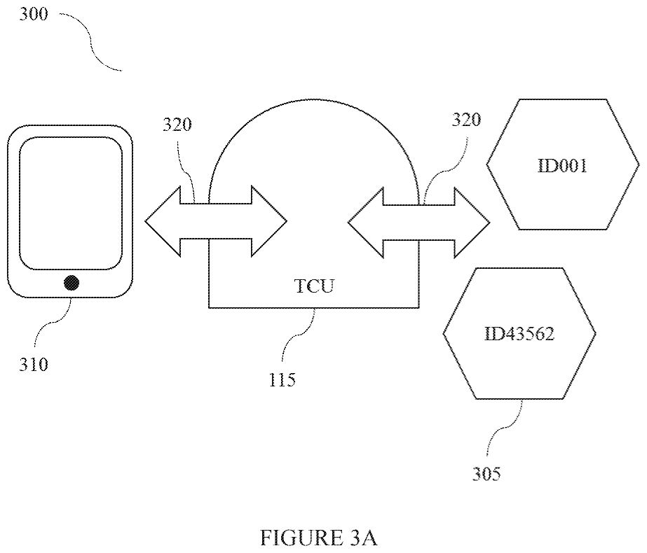

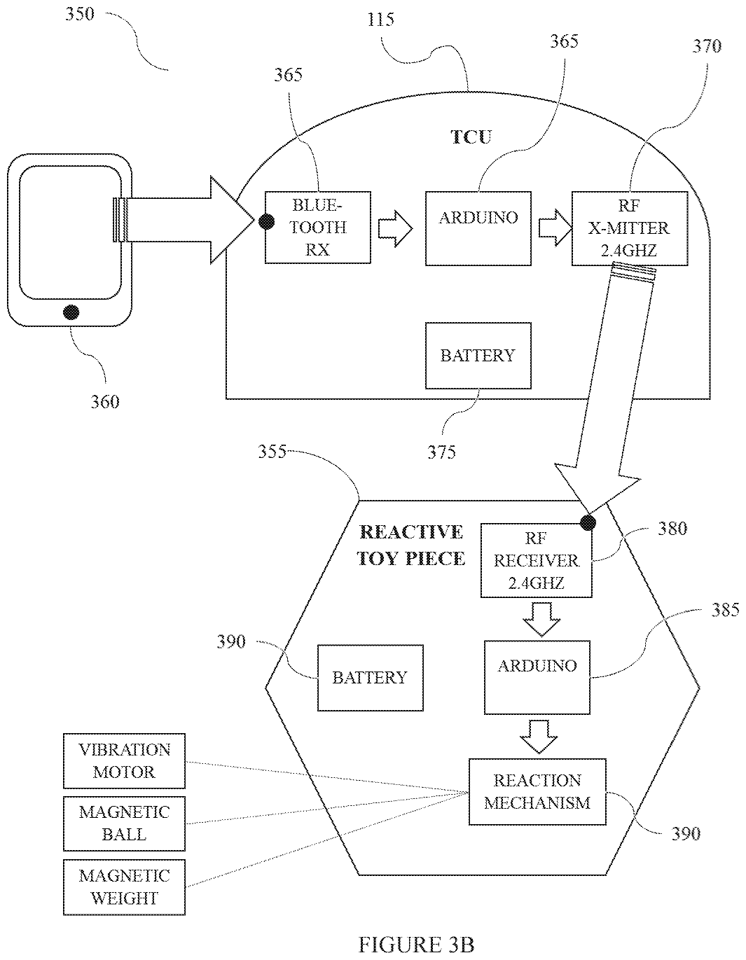

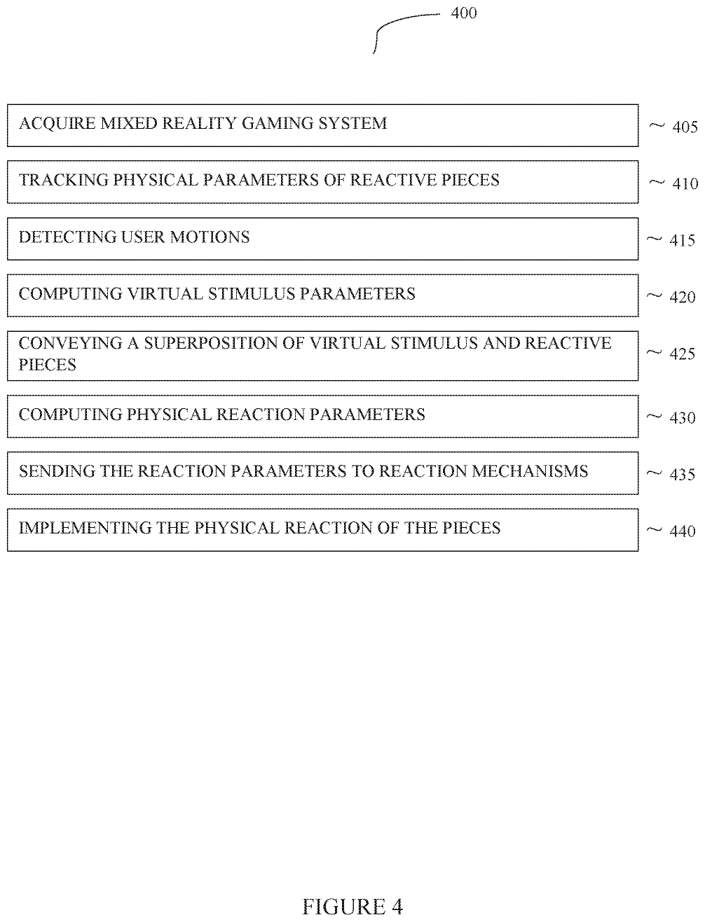

Reference is now also made to FIG. 2A-2C, showing side views and a top view of a reaction mechanism of a reactive piece, according to some embodiments of the invention. The reaction mechanism, in these embodiments, is a magnetic dome base 200, on which a reactive piece is attached.

Magnetic dome base 200 comprises a dome 205 with an internal bowl, a metal ball 210 disposed to roll in the internal bowl, and a plurality of controllable magnets 215.

The V-R synchronizer 123 sends reaction parameters to the reaction mechanism 200. The reaction parameters comprise selective activation of controllable magnets 215 (according to a direction which the V-R synchronizer 123 computed from the stimulus parameters). The magnetic fields thereby created cause the metal ball 210 to roll on the internal bowl in the specified direction, which in turn causes the magnetic dome base 200 to tilt, as shown in FIG. 2B. The tilting base causes the reactive piece 105 to tilt or topple.

In some embodiments, the strengths of magnetic fields generated by controllable magnets 215 are adjustable. PCU magnetic reaction parameters include an adjustment for the strength and/or rate of change of the magnetic field produced by each controllable magnet 215. The extent and/or speed of the tilt/toppling is thereby adjustable, in accordance with the stimulus parameters received from the prompting mechanism 120.

In some embodiments, magnetic dome base 200 comprises at least four magnets, as shown in FIG. 2C. Each pair of opposing magnets can control the magnitude, intensity, and/or rate of change of magnetic fields in an x and y direction, thereby enabling a tilting or toppling reaction along a horizontal axis selectable over 360°. In some alternative embodiments, shown in FIG. 2D, magnetic dome base 250 may be in the shape of a polygon. A polygonal magnetic dome base 250 can restrict the direction of tilt/tipple to directions normal to one of the sides of the polygon.

It is understood that the reaction mechanism described herein is one example. The means of causing a reaction, such as making something fall in a particular direction, can be implemented, alternatively or in addition, in a variety of mechanical method(s) known in the art.

Communication with PCU 115 can be by any one or more suitable wireless standards. For example, communication with detection mechanism 110 can be Bluetooth and communication with reactive pieces 105 can be by 2.4 GHz RF.

Reference is now made to FIG. 3A, showing a block diagram of a mixed reality gaming system 300, according to some embodiments of the invention.

A communication link 310 between a user device 310 and PCU 115 can employ a protocol suitable short distance wireless communication, preferably Bluetooth. Communication link 320 between PCU 115 and reactive pieces 105 (the bases thereof are shown) can also employ a protocol suitable short distance wireless communication, preferably Zigbee or 2.4 GHz RF.

Alternative embodiments of the invention can be a bowling game system in which bowling pins are located on or connected to a physical base unit that activates their falling mechanism when a virtual bowling ball hits them. The system computes how the bowling pins should fall according to the direction, energy and other physical effects a real ball would have created. After movement, if the camera will be aiming the direction of the virtual ball's movement, it is possible to see the virtual ball moving toward the real physical pins and hits them and causes them to physically react as the system computed.

Other embodiments include other real world games like a real soccer ball with a real kick action, bowling and rolling action of the ball with the real hand, and darts with virtual throwing action by real hand, then converted to a virtual action. Movements of real legs or arms recognized by computer vision may represent the movement or power generated to the ball or darts. which in turn initiates the real reaction as taught herein.

The user device may be a mobile device that includes a gyro and/or other movement and momentum detections devices to define the use of the mobile device and its movement, then convert (by computation) the real movement to the movement of a virtual ball, dart, etc. in the direction and with the power computed from the movement of the mobile device.

Reference is now made to FIG. 3B, showing a block diagram of a mixed reality gaming system 300, according to some embodiments of the invention. User device 360 stores locations of reactive pieces 355 and computes stimulus parameters when a prompting mechanism of user device is triggered. User device 360 transmits the stimulus parameters to a Bluetooth receiver 365 of PCU 115. PCU may be powered by a battery 375. A processor board 365 (e.g., Arduino) of PCU computes reaction parameters as a function of the stimulus parameters. An RF transmitter 370 of PCU 115 sends the reaction parameters to an RF receiver 380 of reactive piece 355. Reactive piece 355 may comprise a processor board 385 (which can also be an Arduino board) in order to convert the reaction parameters a format needed to drive reaction mechanism 390. Reaction mechanism 390 can be, for example, a vibration motor, a magnetic dome base (e.g., as further described herein), and/or a magnetic weight mechanism.

1. A mixed reality system for dynamic synchronization between real and virtual environments 100, comprising
a. one or more reactive pieces 105, each comprising a reaction mechanism configured to cause a physical reaction of the reactive piece 105;
b. a tracking mechanism 110, configured to track one or more physical parameters of said reactive pieces 105, said physical parameters comprising at least a location of a said reactive piece 105;
c. a stimulizing mechanism 120, configured to detect one or more motions of a user and compute parameters of a virtual stimulus near said location as a function of said user motions;
d. a mixed-reality output mechanism 122, configured receive said virtual stimulus parameters and convey to the user a superimposition of said virtual stimulus over said reactive piece;
e. a virtuality-reality synchronizer 123, configured to receive said virtual stimulus and compute physical reaction parameters of said reactive piece, as a function of said virtual stimulus and said reactive-piece physical parameters;
wherein said reaction mechanism is configured to receive said physical reaction parameters and to implement said reaction of said reactive piece in accordance with said reaction parameters.

2. The system of claim 1, further comprising a pieces control unit (PCU) 115, in communicative connection with said stimulizing mechanism 120 and said reactive pieces 105, comprising said virtuality-reality synchronizer 123.

3. The system of claim 2, wherein said PCU is further configured to track physical statuses of said reactive pieces and report said physical statuses to a plurality of user devices comprising said tracking mechanism 110, said stimulizing mechanism 120, and said MR output mechanism.

4. The system of claim 2, wherein communication of said PCU to said reactive pieces is by Bluetooth and to said stimulizing mechanism is by Zigbee or 2.4 GHz RF.

5. The system of claim 2, wherein said tracking mechanism comprises a user device with a camera and processor, said system further configured for
a. said camera to be scanned by a user, thereby acquiring images associated with said reactive pieces;
b. said PCU to receive said images and associate each image with an identifier;
c. said processor to receive said identifiers;
d. said processor to compute positions of said reactive pieces;
e. said processor to associate said identifiers with said positions.

6. The system of claim 1, wherein said tracking mechanism employs AR and/or SLAM technology to compute said positions.

7. The system of claim 1, wherein said racking mechanism comprises a wireless triangulation system.

8. The system of claim 1, wherein said tracking mechanism recognizes a sound unique to each particular said reactive piece, wherein said sounds are either humanly audible or heard by said tracking mechanism only.

9. The system of claim 1, wherein said tracking mechanism comprises detection by a said reactive piece of a sound unique to said piece, said sound generated by a user device, each said reactive piece recognizing its own unique sound, wherein said sounds are either humanly audible or heard by said reactive pieces only.

10. The system of claim 1, wherein said racking mechanism comprises one or more touch sensitive surfaces disposed on said operative surface, said system further configured for
a. a user device to receive positions of said reactive pieces from said touch sensitive surface;
b. said reactive pieces each possessing a unique footprint associated with one of said identifiers;
c. said footprints sensed by said touch sensitive surface; and
d. tracking locations of said reactive pieces.

11. The system of claim 1, wherein said reaction mechanism comprises a magnetic dome base 200, comprising:
a. a dome 205 with an internal bowl;
b. a metal ball 210, disposed to roll in said internal bowl; and
c. a plurality of controllable magnets 215;
wherein said virtuality-reality synchronizer is configured to activate controllable magnets, causing said metal ball to roll in said internal bowl thereby tiling or toppling said reactive piece.

12. The system of claim 11, wherein the strengths of the magnetic fields of said controllable magnets is adjustable, and said reaction parameters comprise an adjustment of the magnitude and/or rate of change of the magnetic fields, thereby affecting the extent and/or speed of said tiling or toppling.

13. The system of claim 11, whereby said reaction mechanism comprises at least four magnets, enabling said tiling or toppling along a horizontal axis selectable over 360°.

14. The system of claim 11, wherein said stimulus parameters include position and direction of said prompting mechanism, location and orientation of a said reactive piece virtually hit by said virtual projectile.

15. The system of claim 1, wherein said stimulizing mechanism
a. comprises a gyro to detect user motion
b. is configured for imparting said stimulus parameters with energy, power, and/or direction.

16. A method for dynamic synchronization between real and virtual environments, comprising steps of
a. acquiring the system of claim 1 405;
b. tracking physical parameters of one or more reactive pieces 410;
c. detecting one or more motions of a user 415;
d. computing parameters of a virtual stimulus, as a function of said user motions 420;
e. conveying a superposition of said virtual stimulus, according to said virtual stimulus parameters, over one or more of said reactive pieces 425;
f. computing parameters of a physical reaction of one or more of said reactive pieces, as a function of said virtual stimulus parameters and said reactive-piece physical parameters 430;
wherein said method further comprises steps of sending said physical reaction parameters to one or more of said reaction mechanisms 435 and implementing said physical reaction in accordance with said reaction parameters 440.
